(19) United States
(12) Patent Application Publication
(10) Pub. No.: US 2010/0057989 A1
(43) Pub. Date: Mar. 4, 2010

(54) METHOD OF MOVING DATA IN LOGICAL VOLUME, STORAGE SYSTEM, AND ADMINISTRATIVE COMPUTER

(76) Inventors: Yukinori SAKASHITA, Sagamihara (JP); Yasutaka Kono, Yokohama (JP)

Correspondence Address: MATTINGLY & MALUR, P.C., 1800 DIAGONAL ROAD, SUITE 370, ALEXANDRIA, VA, 22314, US

(21) Appl. No.: 12/254,427

(22) Filed: Oct. 20, 2008

(30) Foreign Application Priority Data
Aug. 26, 2008 (JP) 2008-217216

(51) Int. Cl. G06F 12/02; G06F 12/00; G06F 13/00

(52) U.S. Cl. 711/114; 711/165

(57) ABSTRACT

A data storage system satisfying user's requirements of a thin provisioned volume even if an event has occurred in which the requirements of the thin provisioned volume are not satisfied. When event information is sent from a storage subsystem to an administrative computer, the computer identifies physical resources affected by the event. A decision is made as to whether the identified physical resources satisfy the pool requirements of the thin provisioned volume. If the pool requirements are not satisfied, physical resources satisfying the pool requirements are selected from all physical resources. The administrative computer instructs the storage subsystem to move data. The storage subsystem moves data stored in physical resources affected by the event to physical resources satisfying the pool requirements and modifies the physical resource numbers given to the physical resources affected by the event to the physical resource numbers given to the physical resources satisfying the pool requirements.

### CROSS REFERENCES TO RELATED APPLICATIONS

This application relates to and claims priority from Japanese Patent Application No. 2008-217216, filed on Aug. 26, 2008, the entire disclosure of which is incorporated herein by reference.

### BACKGROUND OF THE INVENTION

1. Field of the Invention

The present invention relates to a method of moving data held in a logical volume and to a storage system. More particularly, the invention relates to a technique of moving data held in a logical volume created by a method of automatically expanding the capacity of a storage device.

2. Description of the Related Art

In recent years, amounts of data held by computer systems have increased amazingly. Consequently, computer systems storing increasing amounts of data have tended to employ storage systems having massive storage capacities.

Storage systems offer storage regions, expressed in logical volumes, to host computers. In the past, a logical volume of a fixed capacity has been created after an administrator has estimated a required storage capacity. In modern storage systems, however, a method of creating logical volumes in such a way as to enhance the efficiency of utilization of storage regions further has been required.

Accordingly, a method of automatically expanding the capacity of a logical volume has emerged in patent reference 1 below. In particular, some regions (segments) of a physical resource are assigned to a logical volume according to an access request from a host computer. Consequently, the capacity of the logical volume has been expanded automatically. A technique regarding external connection is proposed in patent reference 2. In particular, first and second storage devices are connected. When there is an I/O request from a host computer to the first storage device, the I/O request is routed to the second storage device.

A logical volume offered by a method of automatically expanding the capacity is generally referred to as a thin provisioned volume. A logical device on a RAID (redundant array of independent disks) made of plural hard disks is herein referred to as a physical resource.

In the present specification, a technique of managing storage regions of different storage subsystems as a single virtual storage subsystem is referred to as external connection. In a system managed as a single virtual storage subsystem, a storage subsystem having a storage region where data is stored is herein defined as an external storage subsystem.

[Patent reference 1] JP-A-2003-15915

[Patent reference 2] JP-A-2003-5370

### SUMMARY OF THE INVENTION

If an event such as a fault occurs with connection, for example, between the first and second storage devices during operation of a thin provisioned volume offered by the technique disclosed in patent reference 1, some regions of the thin provisioned volume become inaccessible. This presents the problem that it is impossible to satisfy the requirement of thin provisioned volume the user intends.

It is an object of the present invention to provide method of moving data held in a logical volume, storage system, and administrative computer which can satisfy requirements of a thin provisioned volume the user intends if an event occurs in which the requirements of the thin provisioned volume cannot be satisfied when the thin provisioned volume is being used.

This object is achieved in accordance with the teachings of the present invention by a configuration including a storage subsystem and an administrative computer. The storage subsystem exchanges information with a host computer via a communication network, and offers storage regions of storage devices to the host computer in response to an access from the host computer. The administrative computer manages the storage regions of the storage devices as a thin provisioned volume. When an event occurs in which any regions of the thin provisioned volume fail to satisfy storage pool requirements, the administrative computer selects a logical volume satisfying the storage pool requirements of the thin provisioned volume. The storage subsystem rearranges some regions of the thin provisioned volume into a selected logical volume in response to an instruction from the administrative computer.

According to the present invention, when a thin provisioned volume is being exploited, if an event occurs in which any region of the thin provisioned volume fails to satisfy the storage pool requirements, it is possible to satisfy the thin provisioned volume requirements the user intends.

### BRIEF DESCRIPTION OF THE DRAWINGS

FIG. 1 is a block diagram of a computer system according to a first embodiment of the present invention;

FIG. 2 is a physical and logical management table according to the first embodiment;

FIG. 3 is a segment management table according to the first embodiment;

FIGS. 4A-4C show examples of the configuration of a thin provisioned volume according to the first embodiment;

FIG. 5 is a physical resource management table according to the first embodiment;

FIG. 6 is a storage configuration management table according to the first embodiment;

FIG. 7 is a storage pool requirement table according to the first embodiment;

FIG. 8 is a flowchart illustrating a subroutine performed by an event-sending program according to the first embodiment;

FIG. 9 is a flowchart illustrating a subroutine performed by an event reception program according to the first embodiment;

FIG. 10 is a flowchart illustrating a subroutine performed by a thin provisioned volume management program according to the first embodiment;

FIG. 11 is a flowchart illustrating a subroutine performed by a segment-moving instruction program according to the first embodiment;

FIG. 12 is a flowchart illustrating a subroutine performed by a segment-moving program according to the first embodiment;

FIG. 13 is a flowchart illustrating a subroutine performed by a physical and logical information management program according to the first embodiment;

FIG. 14 is a block diagram of a computer system according to a second embodiment of the present invention;

FIG. 15 is an external storage management table according to the second embodiment;

FIG. 16 is a flowchart illustrating a routine or subroutine performed by an event reception program according to the second embodiment;

FIG. 17 is a block diagram of a computer system according to a third embodiment of the present invention;

FIG. 18 is a flowchart illustrating a routine or subroutine performed by an event reception program according to the third embodiment;

FIG. 19 is a flowchart illustrating a routine or subroutine performed by a segment-moving instruction program according to the third embodiment;

FIG. 20 is a flowchart illustrating a subroutine performed by a data-moving program according to the third embodiment; and

FIG. 21 is a flowchart illustrating a routine or subroutine performed by a physical and logical information management program according to the third embodiment.

### DETAILED DESCRIPTION OF THE INVENTION

Embodiments of the present invention are hereinafter described with reference to the drawings. It is to be noted that the invention is not limited thereby.

### Embodiment 1

### (1) System Configuration of First Embodiment

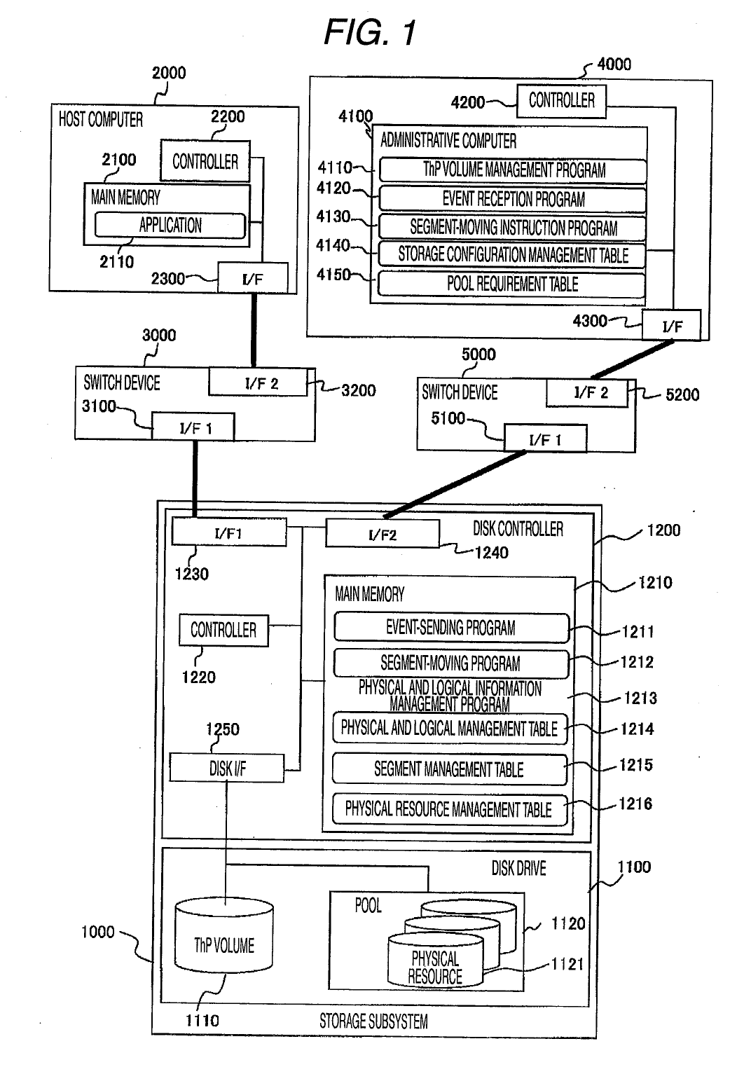

The configuration of a computer system according to the present embodiment is shown in FIG. 1. In the computer system of this embodiment, a storage subsystem 1000 and a host computer 2000 are interconnected by a switch device 3000.

In the present embodiment, the switch device 3000 is an FC (fibre channel) switch device forming a storage area network (SAN). The switch device 3000 may also be an IP (Internet Protocol) network or other switch device adapted for data communications.

The storage subsystem 1000 is connected with an administrative computer 4000 via a switch device 5000. In the present embodiment, the switch device 5000 is an IP switch device. The switch device 5000 may also be a storage area network (SAN) or other network for data communications. The switch device 3000 and switch device 5000 can be the same switch device. The host computer 2000 and administrative computer 4000 can be the same computer.

For convenience of illustration, in FIG. 1, there is one storage subsystem 1000. There is one host computer 2000. There is one switch device 3000. There is one administrative computer 4000. There is one switch device 5000. In the present invention, their numbers can be set at will.

The storage subsystem 1000 is made up of a disk drive 1100 in which data is stored and a disk controller 1200 for controlling the inside of the storage subsystem. The disk drive 1100 has at least one logical volume 1110 and a storage pool 1120. The logical volume 1110 is made of at least one physical resource 1121 and stores data used by the host computer 2000. For convenience of illustration, there is one storage pool 1120 in FIG. 1, but the present invention is not limited to this number.

The storage pool 1120 has at least one physical resource 1121. The pool 1120 is a logical group for managing all of the physical resources 1121 which are made of a RAID array, for example. One example of RAID array is RAID 0 in which plural hard disks are striped into one massive storage area to offer a large capacity. Another example is RAID 1 in which mirroring of hard disks is provided to enhance the redundancy of the hard disks.

The disk controller 1200 has a main memory 1210, a controller 1220, an I/F1 1230, an I/F2 1240, and a disk I/F 1250. An event-sending program 1211, a segment-moving program 1212, a physical and logical information management program 1213, a physical and logical management table 1214, a segment management table 1215, and a physical resource management table 1216 are stored in the main memory 1210.

When an event such as a fault is detected, the event-sending program 1211 sends information about the event to the administrative computer 4000 that manages the storage subsystem 1000. The segment-moving program 1212 moves data, which is held in a segment utilized in the thin provisioned volume 1110, into another segment according to an instruction from the administrative computer 4000. The physical and logical information management program 1213 references or updates the information held in the physical and logical management table 1214 and segment management table 1215 and manages the information about the configuration of the thin provisioned volume 1110. Information about the characteristics of the physical resource 1121 such as presence or absence of redundancy is stored in the physical resource management table 1216.

The controller 1220 reads out and executes the event-sending program 1211, segment-moving program 1212, and physical and logical information management program 1213 stored in the main memory 1210.

The I/F1 1230 is an interface with the switch device 3000, and sends and receives data and control instructions to and from the host computer 2000. The I/F2 1240 is an interface with the switch device 5000, and sends and receives data and control instructions to and from the administrative computer 4000. The disk I/F 1250 is an interface with the disk drive 1100, and sends and receives data and control instructions.

The host computer 2000 is made up of a main memory 2100, a controller 2200, and an I/F 2300. The host computer 2000 may be equipped with input devices such as a keyboard and a display device (not shown).

An application program 2110 that makes access to the thin provisioned volume 1110 of the storage subsystem 1000 is stored in the main memory 2100. One example of the application program 2110 is a DBMS (database management system). The controller 2200 reads the application program 2110 from the main memory 2100 and executes the program.

The I/F 2300 is an interface with the switch device 3000, and sends and receives data and control instructions to and from the storage subsystem 1000. The switch device 3000 is made up of I/F1 3100 and I/F2 3200. The I/F1 3100 is an interface with the storage subsystem 1000, and sends and receives data and control instructions to and from the storage subsystem 1000. The I/F2 3200 is an interface with the host computer 2000, and sends and receives data and control instructions to and from the host computer 2000. For convenience of illustration, each of the I/F1 and I/F2 is treated as singular in number but each of them may also be plural in number.

The administrative computer 4000 is made of an administrative portion including a main memory 4100, a controller 4200, and an I/F 4300. The administrative computer 4000 may be equipped with input devices such as a keyboard and a display device (not shown).

A thin provisioned (ThP) volume management program 4110, an event reception program 4120, a segment-moving instruction program 4130, a storage configuration management table 4140, and a pool requirement table 4150 are stored in the main memory 4100.

When information about an event is received from the event reception program 4120, the thin provisioned volume management program 4110 acquires the segment management table 1215 and physical resource management table 1216 from the storage subsystem 1000, searches the pool requirement table 4150 for a segment satisfying storage pool requirements, and sends an instruction for shifting of the segment to the segment-moving instruction program 4130.

After receiving information about an event such as a fault from the storage subsystem 1000, the event reception program 4120 makes a decision as to whether the pool requirements are no longer satisfied because of the results of the event information received from the pool requirement table 4150. If the requirements are no longer satisfied, the reception program 4120 calls the thin provisioned volume management program 4110.

After receiving the physical resource number given to the source segment and the physical resource number given to the destination segment from the thin provisioned volume management program 4110, the segment-moving instruction program 4130 sends an instruction to the segment-moving program 1212 of the storage subsystem 1000 to move the physical resource.

The storage configuration management table 4140 stores information indicating the connection configuration from the thin provisioned volume 1110 of the storage subsystem 1000 to the host computer 2000.

The pool requirement table 4150 holds information indicating the connection configuration. Examples of the information indicating the connection configuration include LUN (logical unit number) that is an identifier for the thin provisioned volume 1110, identification name of the host computer 2000 to which the thin provisioned volume 1110 is assigned, identification name of the I/F used for communications with the host computer 2000, and identification name of a switch device used for connection of the storage subsystem 1000 and host computer 2000. User's requirements for the pool 1120 from which the thin provisioned volume 1110 has been created are stored in the pool requirement table 4150. As an example, a pool number for identification of the pool and pool requirements are held in the table.

The controller 4200 reads the thin provisioned volume management program 4110, event reception program 4120, and segment-moving instruction program 4130 from the main memory 4100 and executes these programs.

The I/F 4300 is an interface with the switch device 5000, and sends and receives data and control instructions to and from the storage subsystem 1000. The switch device 5000 is made up of I/F1 5100 and I/F2 5200. The I/F1 5100 is an interface with the storage subsystem 1000, and sends and receives data and control instructions to and from the storage subsystem 1000. The I/F2 5200 is an interface with the administrative computer 4000, and sends and receives data and control instructions to and from the administrative computer 4000. For convenience of illustration, each of the interfaces I/F1 and I/F2 is treated as singular in number but each of them may also be plural in number.

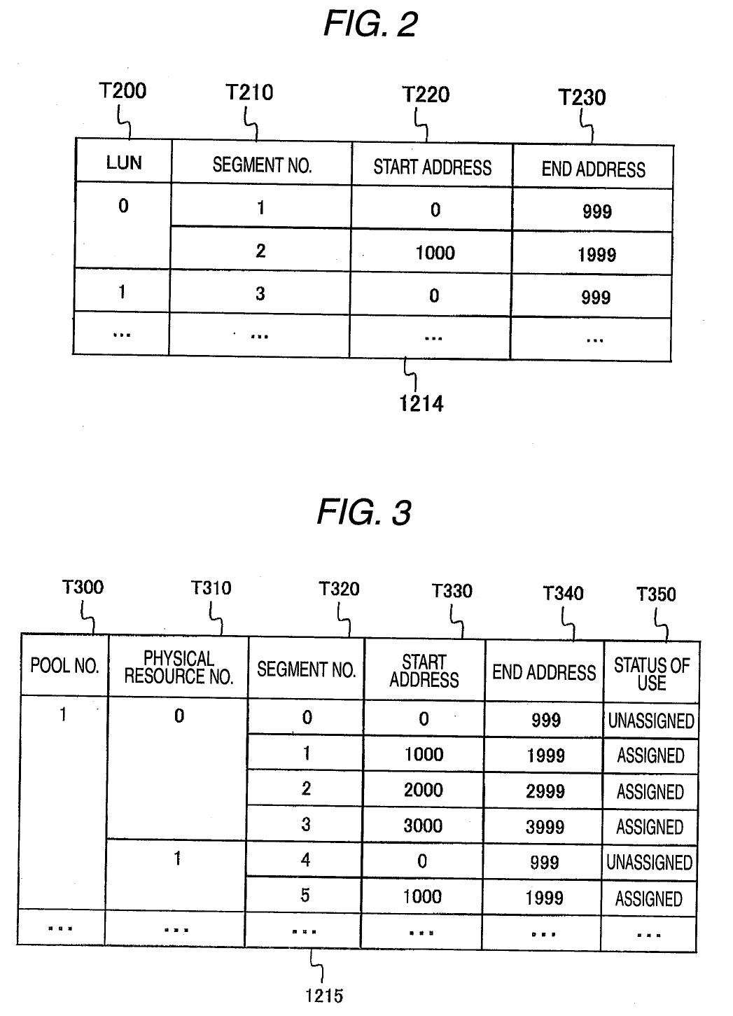

FIG. 2 shows the physical and logical management table 1214 of the present embodiment. The management table 1214 holds information indicating the configuration of the thin provisioned volume. Examples of the information indicating the configuration include LUN T200, segment number T210, start address T220, and end address T230.

A number for identification of the logical volume 1110 is stored in the LUN T200. A number for identifying a segment already assigned to a virtual volume is stored in the segment number T210. The start address T220 and end address T230 indicate addresses of a logical volume offered to the host computer 2000. An LBA (logical block address) is generally used as the address of a logical volume.

The segment management table 1215 of the present embodiment is shown in FIG. 3. This table 1215 holds information for management of segments, the information including information about pool number T300, physical resource number T310, segment number T320, start address T330, end address T340, and status of use T350.

Information for identifying a pool that is a logical group for managing all of physical resources 1121 is stored in the pool number T300. Information for identifying each physical resource 1121 is stored in the physical resource number T310.

Information for identifying each segment obtained by logically dividing each physical resource 1121 into arbitrary size is stored in the segment number T320. The start address T330 and end address T340 indicate addresses of a segment on the physical resource 1121. LBA is generally used as an address of a physical address.

Information indicating whether or not a segment has been assigned to the logical volume 1110 is stored in the status of use T350. One state of the status of use is “assigned”, which indicates that a segment has been assigned to a logical volume. The other state of the status of use is “unassigned”, which indicates that no segment is assigned to the logical volume. For convenience of illustration, the status of use is represented by a character string in FIG. 3. This may be replaced by an identifiable numeral or the like and stored.

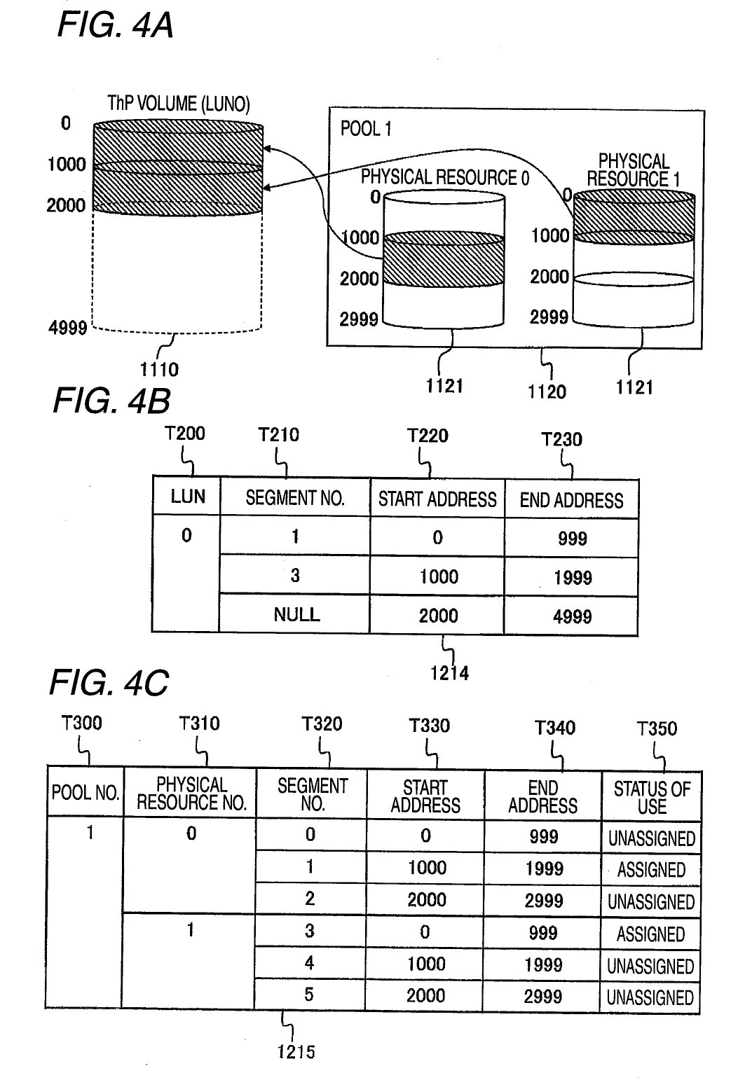

The configuration of the logical volume 1110 of the present embodiment is particularly shown in FIG. 4A. A specific example of the physical and logical management table 1214 already described in connection with FIG. 2 is shown in FIG. 4B. A specific example of the segment management table 1215 already described in connection with FIG. 3 is shown in FIG. 4C.

As shown in FIG. 4A, the logical volume 1110 is made up of one or more physical resources 1121. In the example of FIG. 4A, a segment of a first physical resource (physical resource 1) 1121 of a first pool region (pool 1) 1120 and a segment of a second physical resource (physical resource 2) 1121 are assigned to the logical volume 1110 having a variable capacity.

In this case, the LUN of the thin provisioned volume 1110, i.e., “0”, is stored as a number permitting the host computer 2000 to identify the thin provisioned volume 1110 into the LUN T200 of the physical and logical management table 1214 (FIG. 4B). Numerals “1” and “3” for identifying the segments assigned to the logical volume 1110 are stored in the segment number T210. “NULL” is stored in each region to which a segment is not yet assigned. For convenience of illustration, “NULL” is stored in each unassigned region of FIG. 4B. Another character string or numeral indicating non-assignment may be stored instead. Addresses of various regions employed by the host computer 2000 are stored in the start address T220 and end address T230 of the physical and logical management table 1214.

As shown in FIG. 4C, an identification number “1” for the first pool region 1120 is stored in the pool number T300 of the segment management table 1215. In this example, the first pool region 1120 is made up of first and second physical resources 1121 having physical resource numbers of “0” and “1”, respectively. Therefore, these numbers are stored in the physical resource number T310.

Furthermore, as shown in FIG. 4A, each of the first and second physical resources is made of 3 segments in this example. Segment numbers 0 to 5 are assigned to the segments, respectively. These numbers are stored in the segment number T320 of the segment management table 1215.

Start and end addresses of each segment are stored in the start address T330 and end address T340, respectively. A status of use (“unassigned” or “assigned”) of a corresponding segment is stored in each status of use T350. In the case of this example, segments having segment numbers “1” and “3” are assigned to the logical volume 1110 and so information indicating “assigned” status is stored in the corresponding status of use T350. Information indicating “unassigned” status is stored in the status of use T350 corresponding to the other segments.

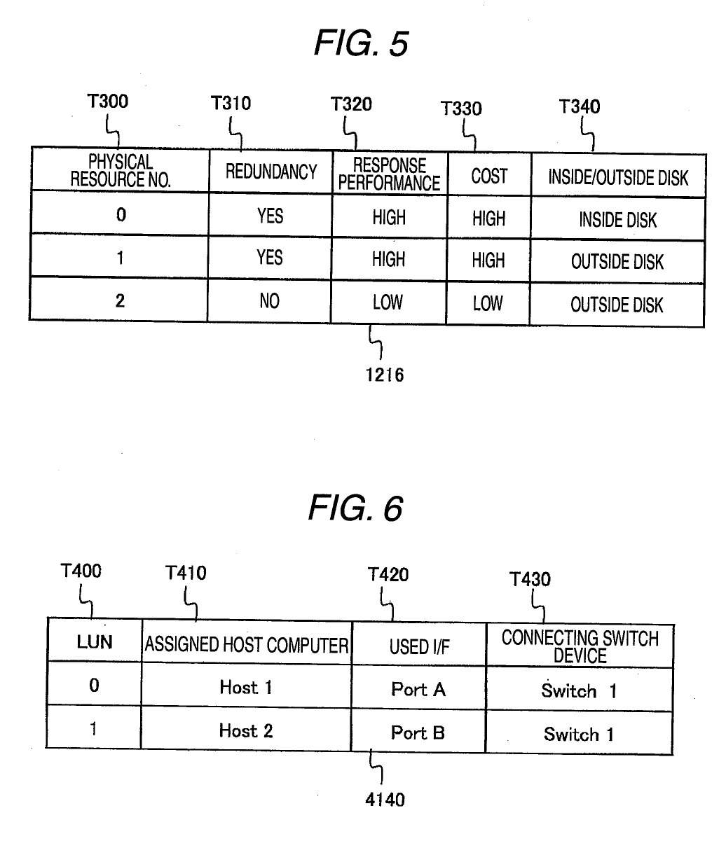

The physical resource management table 1216 of the present embodiment is shown in FIG. 5. The management table 1216 has physical resource number T300 as information for management of the physical resource. The management table 1216 has redundancy T310, response performance T320, cost T330, and inside/outside disk T340 as information indicating the characteristics of the physical resource 1121.

For convenience of illustration, the redundancy, response performance, cost, and inside/outside disk are held as the information indicating the characteristics of the physical resource. Other information such as presence or absence of power saving function, RAID level, amount by which the cache memory is used, capacity, offering vendor, and size may also be held.

An identification number for the physical resource 1121 is stored in the physical resource number T300. Information indicating whether or not the physical resource 1121 has redundancy is stored in the redundancy T310. Information indicating whether the response performance of the physical resource 1121 is high or low is stored in the response performance T320. Information indicating whether the cost of the physical resource 1121 is high or low is stored in the cost T330.

In the present specification, for convenience of illustration, the aforementioned information is used as information indicating the characteristics of the physical resource. Any other information may also be used as long as it indicates the characteristics of the physical resource. For instance, the response performance T320 may be information indicating the transfer rate per unit time.

The storage configuration management table 4140 of the present embodiment is shown in FIG. 6. The table 4140 holds information indicating the connection configuration from the thin provisioned volume of the storage subsystem 1000 to the host computer 2000. The information indicating the connection configuration includes LUN T400, assigned host computer T410, used I/F T420, and connecting switch device T430. The identification information about the thin provisioned volume is stored in the LUN T400. In the present specification, LUN is used as the information for identification of the thin provisioned volume. Other identification information replacing LUN may also be used.

Identification information about the host computer 2000 to which the thin provisioned volume has been assigned is stored in the assigned host computer T410. Identification information about the I/F1 1230 used for communications of the thin provisioned volume and host computer 2000 is stored in the used I/F T420. Identification information for the switch device 3000 used for communications of the thin provisioned volume and host computer 2000 is stored in the connecting switch device T430.

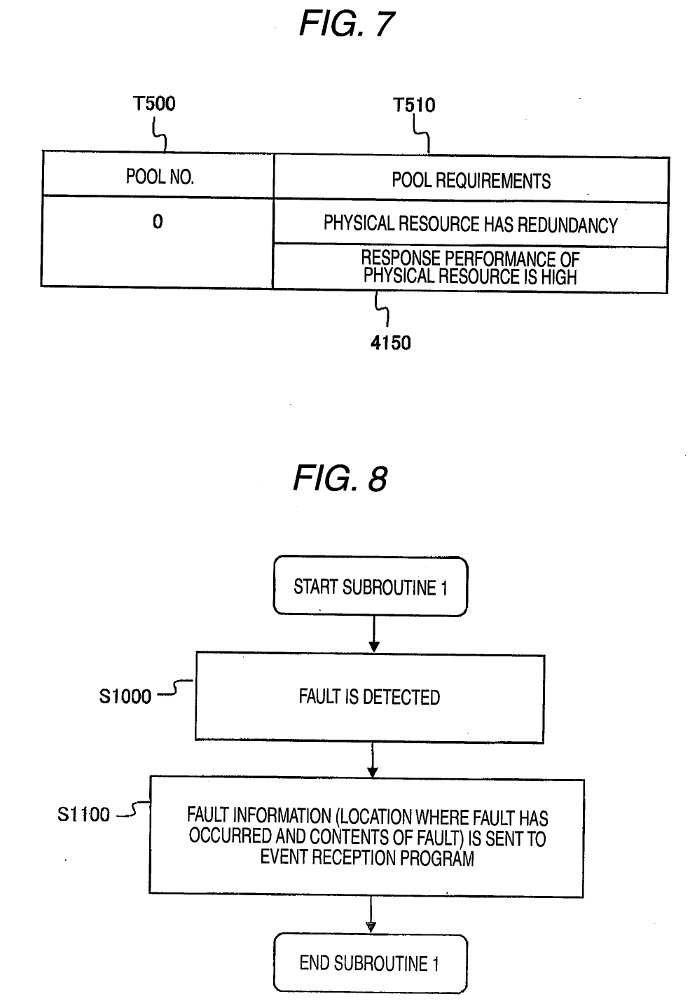

The pool requirement table 4150 of the present embodiment is shown in FIG. 7. Information indicating user's requirements of each pool is held in the pool requirement table 4150. The information indicating the user's requirements includes pool number T500 and pool requirement T510. Identification information about the pool 1120 that has created the thin provisioned volume is stored in the pool number T500. Information about requirements that the pool 1120 must satisfy is stored in the pool requirement T510. In the present specification, for convenience of illustration, the pool requirement information is expressed by one item. Instead, the requirement information may be divided into plural items and represented.

### (2) Operation of First Embodiment

First, the subroutine performed by the event-sending program 1211 is described by referring to FIG. 8. An event in which the storage pool requirements are not satisfied has occurred with any regions of the thin provisioned volume 1110. The event-sending program 1211 detects a fault (S1000), for example. In the present specification, for convenience of illustration, the detected event is a fault. The detected event can be other events such as an instruction from other user or performance deterioration due to high load on the storage subsystem.

Then, the event-sending program 1211 sends information about a fault to the event reception program 4120. The information about the fault includes information for identification of a location where the fault has occurred, the contents of the fault, the importance, and the time at which the fault occurred. In the present specification, for convenience of illustration, it is assumed that a fault has occurred with any one of the hard disks constituting the physical resource. A physical resource number is the information for identifying the location where the fault whose information is sent occurred.

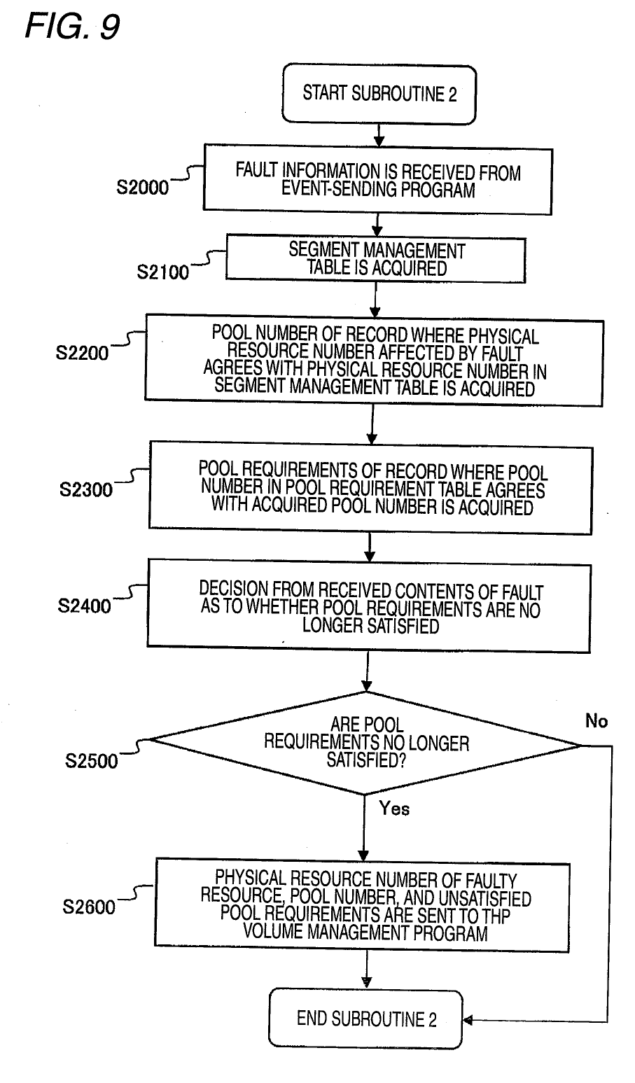

The routine performed by the event reception program 4120 is described by referring to FIG. 9. The reception program 4120 receives the fault information including the physical resource number at which the fault occurred from the event-sending program 1211 of the storage subsystem 1000 (S2000).

The event reception program 4120 then acquires the segment management table 1215 from the storage subsystem 1000 (S2100). Then, the event reception program 4120 acquires the pool number T300 of a record where the identification number of the physical resource affected by the fault is coincident with the physical resource number T310 of the segment management table 1215 (S2200).

The event reception program 4120 then acquires the pool requirement T510 of the record where the pool number obtained by the step S2200 is coincident with the pool number T500 of the pool requirement table 4150 (S2300).

Then, the event reception program 4120 makes a decision from the received contents of fault as to whether the pool requirement T510 is no longer satisfied (S2400). If the decision is that the pool requirement is satisfied, the event reception program 4120 terminates the routine (S2500).

On the other hand, if the decision is that the pool requirement is not satisfied, the event reception program 4120 sends physical resource numbers and pool numbers at which the fault has occurred and the unsatisfied pool requirement to the thin provisioned volume management program 4110 (S2600).

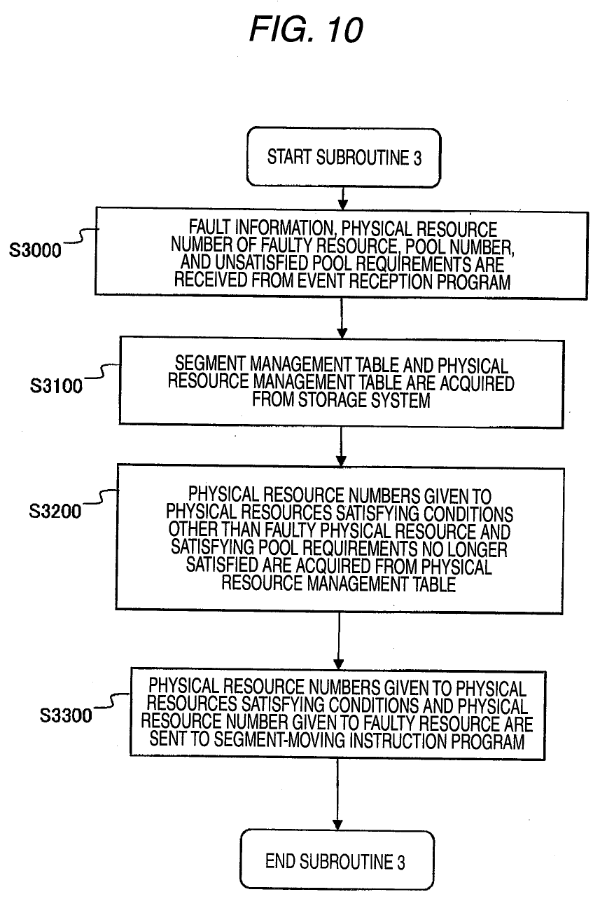

The subroutine performed by the thin provisioned volume management program 4110 is described by referring to FIG. 10. The management program 4110 receives fault information, the physical resource numbers and pool numbers at which the fault has occurred, and the unsatisfied pool requirement from the event reception program 4120 (S3000).

The thin provisioned volume management program 4110 acquires the segment management table 1215 and physical resource management table 1216 from the storage subsystem 1000 (S3100).

Then, the thin provisioned volume management program 4110 acquires a physical resource number, which satisfies the unsatisfied pool requirements and conditions other than the faulty physical resource, from the acquired physical resource management table 1216 (S3200).

The thin provisioned volume management program 4110 then sends the physical resource number satisfying the acquired conditions and the physical resource number where the fault has occurred to the segment-moving instruction program 4130 (S3300).

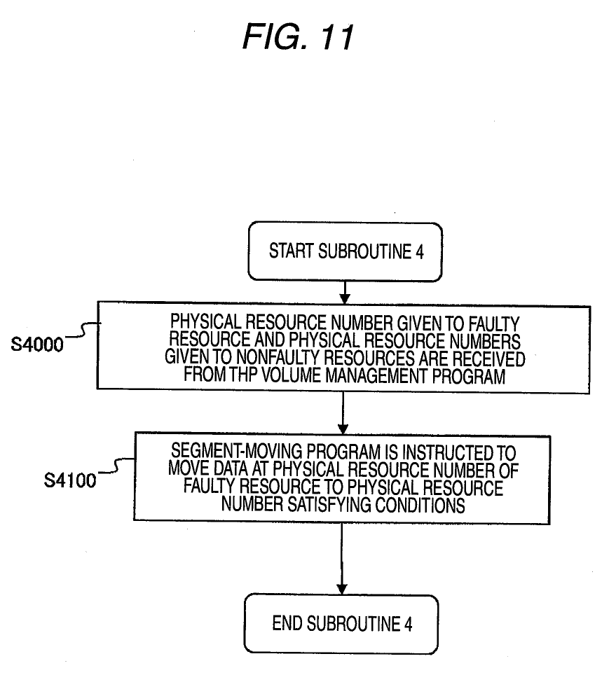

The subroutine executed by the segment-moving instruction program 4130 is next described by referring to FIG. 11. The instruction program 4130 receives the physical resource number satisfying the acquired conditions and the physical resource number where the fault has occurred from the thin provisioned volume management program 4110 (S4000).

The segment-moving instruction program 4130 sends an instruction to the segment-moving program 1212 to cause it to move data stored in the faulty physical resource to a physical resource satisfying the conditions (S4100).

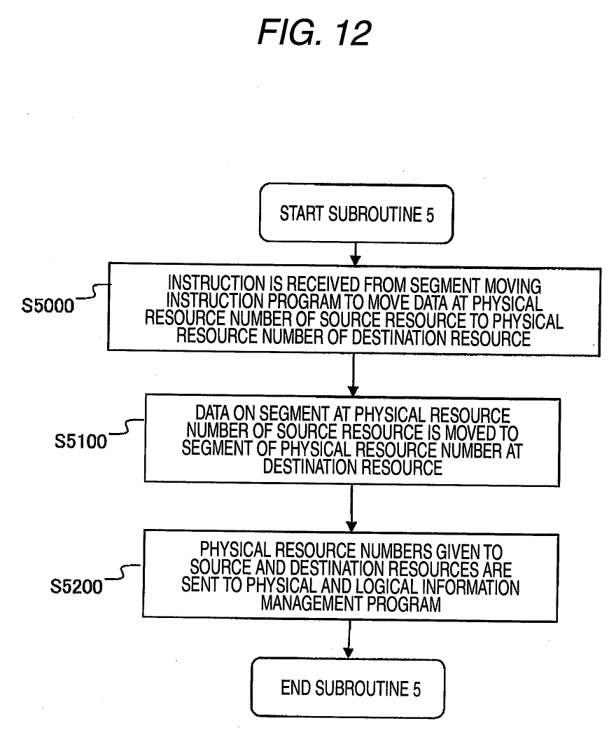

The subroutine executed by the segment-moving program 1212 is next described by referring to FIG. 12. The segment-moving program 1212 receives an instruction for moving the data stored in the faulty physical resource into a physical resource satisfying the conditions from the segment-moving instruction program 4130 (S5000).

The segment-moving program 1212 moves the data stored in the faulty physical resource into a physical resource satisfying the conditions (S5100). In the present specification, for convenience of illustration, the subroutine consists of moving data. The subroutine may also be a copy operation in which data is not deleted from the source resource.

Then, the segment-moving program 1212 sends the physical resource number of the faulty resource (i.e., the source segment) and a physical resource number satisfying the conditions (i.e., the destination segment) to the physical and logical information management program 1213 (S5200).

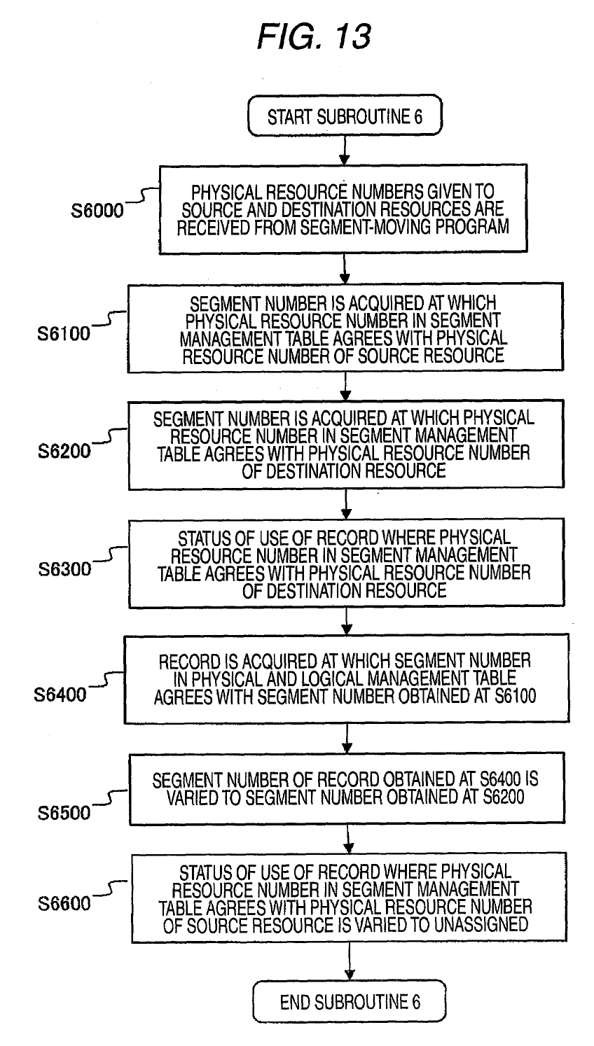

The subroutine performed by the physical and logical information management program 1213 is described by referring to FIG. 13. The management program 1213 receives the physical resource number of the source resource and the physical resource number of the destination resource from the segment-moving program 1212 (S6000).

The physical and logical information management program 1213 then acquires the segment number T220 at which the physical resource number T210 in the segment management table 1215 is coincident with the physical resource number of the source resource (S6100).

Furthermore, the physical and logical information management program 1213 then acquires the segment number T220 at which the physical resource number T210 in the segment management table 1215 is coincident with the physical resource number of the destination resource (S6200).

Then, the physical and logical information management program 1213 modifies the status of use T250 of the record where the physical resource number T210 in the segment management table 1215 is coincident with the physical resource number of the destination source to “assigned” (S6300).

Subsequently, the physical and logical information management program 1213 acquires a record where the segment number T110 of the physical and logical management table 1215 is coincident with the segment number acquired at the step S6100 (S6400).

Then, the physical and logical information management program 1213 modifies the segment number of the record acquired at the step S6400 to the segment number acquired by the step S6200 (S6500).

The physical and logical information management program 1213 then modifies the status of use T250 of the record where the physical resource number T210 in the segment management table 1215 is coincident with the physical resource number of the source resource to “unassigned” (S6600).

As described so far, according to the first embodiment, if an event such as a fault with the storage subsystem 1000 is detected, physical resources affected by the event are identified. Then, the pool requirement table 4150 is referenced. A check is made to confirm that the storage pool requirements are no longer satisfied. When the requirements are no longer satisfied, the physical resource 1121 capable of satisfying the pool requirements is selected from the storage configuration management table 4140, physical and logical management table 1214, and segment management table 1215. Data stored in the physical resource 1121 affected by the event is shifted into the physical resource 1121 capable of satisfying the pool requirements. The physical resource numbers given to the physical resource 1121 which is contained in the physical and logical management table 1214 and in the segment management table 1215 and which is affected by the event are modified to the physical resource numbers given to the physical resources 1121 capable of satisfying the pool requirements. Consequently, if an event such as a fault has occurred, the requirements of the thin provisioned volume 1110 can be satisfied.

### Second Embodiment

The second embodiment uses a system configuration different from that of the first embodiment to perform processing for satisfying the requirements of a thin provisioned volume created when an event such as a fault occurs. In the first embodiment described previously, processing is performed on the assumption that the physical resources 1121 being the components of the thin provisioned volume 1110 required by the storage subsystem 1000 shown in FIG. 1 are all possessed by the same storage subsystem 1000. In the second embodiment described below, however, the entities of some physical resources 1121 of the storage subsystem 1000 yield the same advantages as the first embodiment under the system configuration constituted by an external storage subsystem 6000.

### (1) System Configuration of Second Embodiment

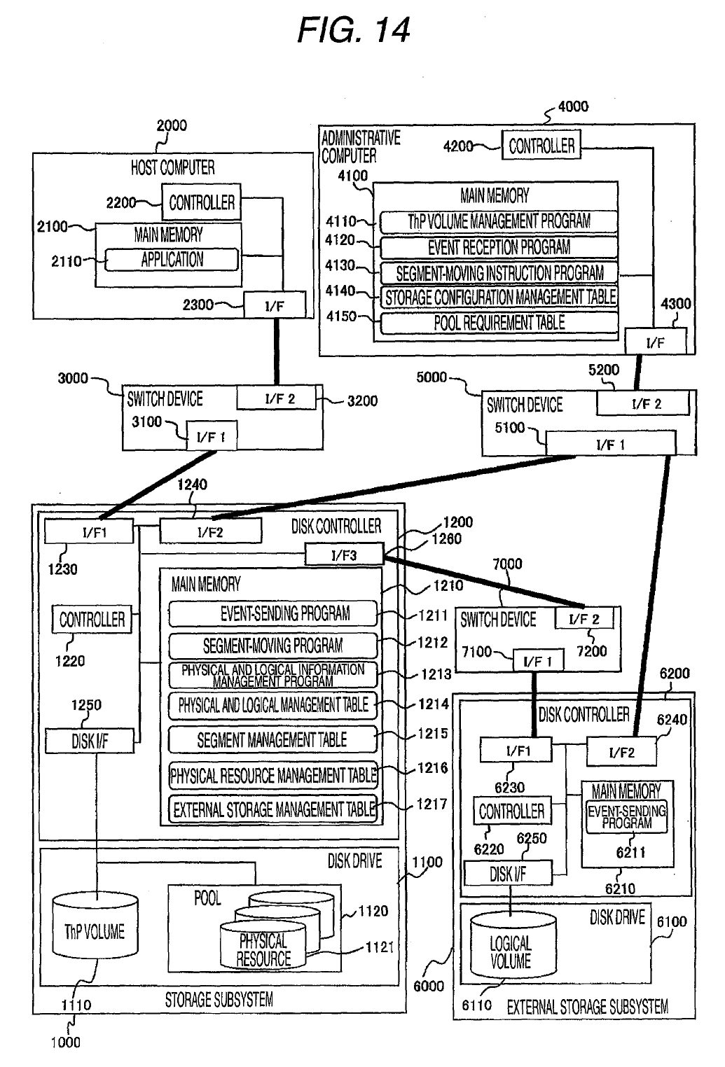

The system configuration of the second embodiment is similar in most respects to that of the first embodiment. Therefore, only different structures are described. The configuration of a computer system used in the second embodiment is shown in FIG. 14.

The computer system of the second embodiment has the structures of the computer system of the first embodiment shown in FIG. 1. Furthermore, in the computer system of the second embodiment, the storage subsystem 1000 and external storage subsystem 6000 are interconnected by a switch device 7000.

In the present embodiment, the switch device 7000 is an FC switch device forming a SAN similarly to the switch device 3000 described previously. The switch device 7000 may also be an IP network or other switch device for data communications.

The storage subsystem 1000 has the components of the first embodiment. In addition, the storage subsystem 1000 has I/F3 1260 on the disk controller 1200 connected with the switch device 7000 and an external storage management table 1217 stored in the main memory 1210.

The I/F3 1260 is an interface with the switch device 7000, and sends and receives data and control instructions to and from the external storage subsystem 6000. The external storage management table 1217 holds information indicating the interrelationship between the logical volume 6110 possessed by external storage subsystem 6000 and physical resource 1121 possessed by the storage subsystem 1000. The storage subsystem 6000 is made up of a disk drive 6100 for storing data and a disk controller 6200 controlling the inside of the storage subsystem.

The disk drive 6100 has at least one logical volume 6110, which stores data used by the host computer 2000 via the storage subsystem 1000. For convenience of illustration, the logical volume is made of a volume of fixed capacity rather than a thin provisioned volume in FIG. 14. The logical volume may also be a thin provisioned volume. Additionally, a pool (not shown) from which the logical volume 6110 is created similarly to the storage subsystem 1000 and physical resources (not shown) may also be provided. The disk controller 1200 has a main memory 6210, a controller 6220, I/F1 6230, I/F2 6240, and a disk I/F 6250.

An event-sending program 6211 is stored in the main memory 6210. When an event such as a fault is detected, the event-sending program 6211 sends information about the event to the administrative computer 4000 that manages the storage subsystem 6000. The controller 6220 reads out and executes the event-sending program 6211 stored in the main memory 6210.

The I/F1 6230 is an interface with the switch device 7000, and sends and receives data and control instructions to and from the storage subsystem 1000. The I/F2 6240 is an interface with the switch device 7000, and sends and receives data and control instructions to and from the administrative computer 4000. The disk I/F 6250 is an interface with the disk drive 6100, and sends and receives data and control instructions.

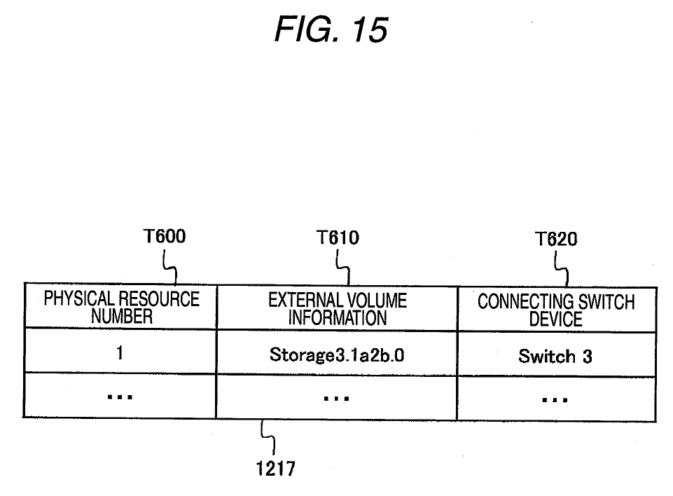

The external storage management table 1217 of the present embodiment is shown in FIG. 15. The external storage management table 1217 holds information about connection between the storage subsystem 1000 and external storage subsystem 6000, the information including information about physical resource number T600, external volume information T610, and connecting switch device T620.

Information for identifying the physical resource 1121 of the storage subsystem 1000 made to correspond to the logical volume 6110 possessed by the external storage subsystem 6000 is stored in the physical resource number T600. Information for identifying the logical volume 6110 possessed by the external storage subsystem 6000 is stored in the external volume information T610.

For convenience of illustration, the information for identifying the logical volume 6110 is made of combinatorial information of model name of the external storage subsystem, serial number, and LUN (logical unit number) assigned to the logical volume. Any form can be used as long as the information can identify the logical volume. Information for identifying the switch device 7000 used for connection between the storage subsystem 1000 and external storage subsystem 6000 is stored in the connecting switch device T620.

### (2) Operation of Second Embodiment

The second embodiment is similar in operation to the first embodiment except for the points described below. The subroutine performed by the event-sending program 6211 in the second embodiment is next described by referring to FIG. 8.

The event-sending program 6211 detects a fault (S1000). In the present specification, for convenience of illustration, the detected event can be other events such as an instruction from other user or performance deterioration due to high load on the storage subsystem.

Then, the event-sending program 6211 sends information about the event to the event reception program 4120. The information about the event includes information for identification of a location where the event has occurred, the contents of the fault, the importance, and the time at which the fault occurred. In the present specification, for convenience of illustration, it is assumed that a fault has occurred with any one of the hard disks constituting the logical volume 6110 possessed by the external storage subsystem 6000. The sent information for identifying the location where a fault has occurred is made of combinatorial information of model name of the external storage subsystem, serial number, and LUN (logical unit number) assigned to the logical volume, to identify the logical volume 6110.

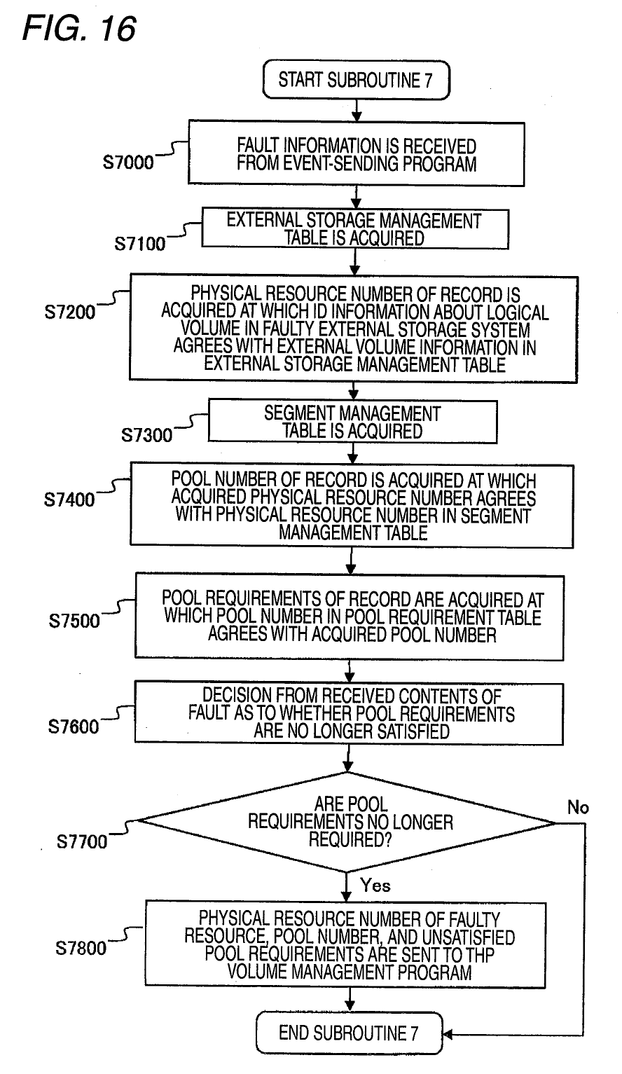

The routine performed by the event reception program 4120 is described by referring to FIG. 16. The event reception program 4120 receives fault information including information for identification of the faulty logical volume from the event-sending program 6211 of the external storage subsystem 6000 (S7000).

Then, the event reception program 4120 acquires the external storage management table 1217 from the storage subsystem 1000 (S7100). Subsequently, the event reception program 4120 acquires the physical resource number T600 of a record where the identification information about the faulty logical volume 6110 of the external storage subsystem 6000 is coincident with the external volume information T610 in the external storage management table 1217 (S7200).

The event reception program 4120 then obtains the segment management table 1215 from the storage subsystem 1000 (S7300). Then, the event reception program 4120 acquires the pool number T300 of a record where the identification number of the physical resource acquired in the step S7200 is coincident with the physical resource number T310 in the segment management table 1215 (S7400).

The event reception program 4120 then acquires the pool requirement T510 of the record where the pool number obtained at the step S7400 is coincident with the pool number T500 in the pool requirement table 4150 (S7500). Then, a decision is made from the received contents of fault as to whether the pool requirement T510 is no longer satisfied (S7600). If the decision is that the pool requirement is satisfied, the event reception program 4120 terminates the routine (S7700).

On the other hand, if the decision is that the pool requirement is no longer satisfied, the event reception program 4120 sends the physical resource number and pool number of the faulty physical resource to the thin provisioned volume management program 4110 as well as the unsatisfied pool requirement (S7800). The second embodiment is similar to the first embodiment in other operations.

As described so far, the second embodiment can yield the same advantages as the first embodiment even if some of the physical resources 1121 being components of the thin provisioned volume 1110 required by the storage subsystem 1000 are under the system configuration built by the logical volume 6110 of the external storage subsystem 6000.

### Third Embodiment

The third embodiment uses a system configuration different from that of the second embodiment to perform processing for satisfying the requirements of a thin provisioned volume 1110 created when an event such as a fault occurs. In the above-described second embodiment, processing is performed under the system configuration where entities of some physical resources 1121 of the storage subsystem 1000 are contained in the first external storage subsystem (1) 6000. However, the third embodiment yields the same advantages as the second embodiment under a system configuration where entities of some physical resources 1121 of the storage subsystem 1000 are contained in the first external storage subsystem 6000 and in the second external storage subsystem 6000.

### (1) System Configuration of Third Embodiment

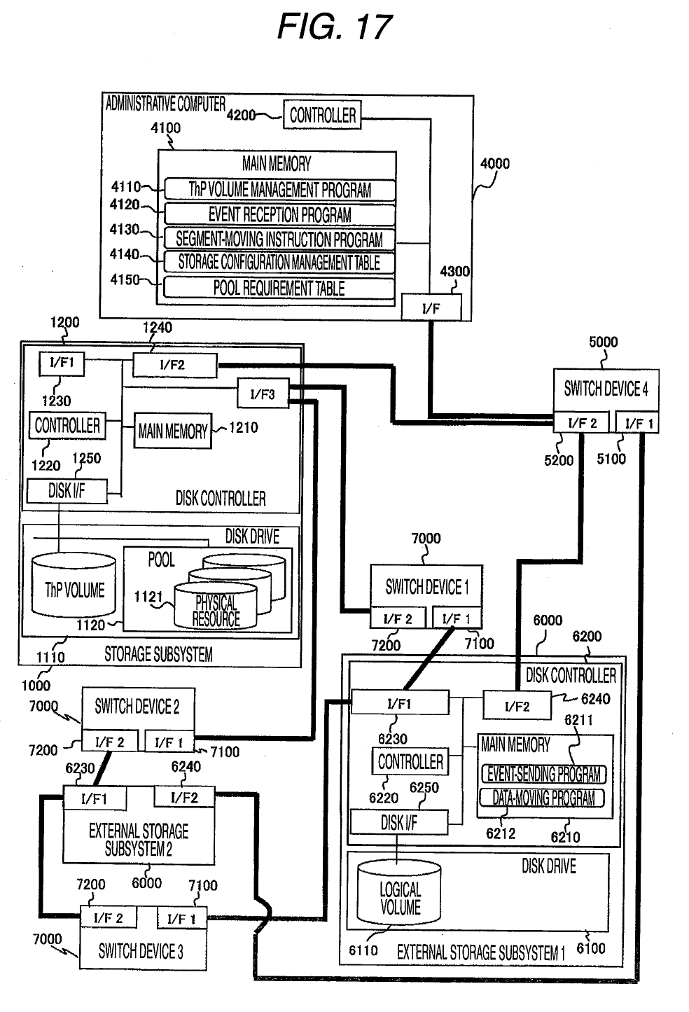

The system configuration of the third embodiment is similar in most respects to that of the second embodiment. Therefore, only different structures are described. The configuration of a computer system according to the third embodiment is shown in FIG. 17.

In the computer system of the third embodiment, the storage subsystem 1000, first external storage subsystem 6000, and second external storage subsystem 6000 are interconnected by a first switch device 7000 and a second switch device 7000. In the present embodiment, each switch device 7000 is an FC switch device forming a SAN. The switch device 7000 may also be an IP network or other switch device for data communications. The first external storage subsystem 6000 is connected with the second external storage subsystem 6000 by a third switch device 7000.

The first external storage subsystem 6000, second external storage subsystem 6000, and administrative computer 4000 are interconnected by a fourth switch device 5000.

Each of the first external storage subsystem 6000 and second external storage subsystem 6000 has the components of the second embodiment and further contains a data-moving program 6212 for moving a specified data region. The program 6212 is stored in the main memory 1210.

For convenience of illustration, the host computer 2000, switch device 3000 interconnecting the host computer 2000 and storage subsystem 1000, and various programs and tables (event-sending program 1211, segment-moving program 1212, physical and logical information management program 1213, physical and logical management table 1214, segment management table 1215, physical resource management table 1216, and external storage management table 1217 in the main memory 1210 of the storage subsystem 1000) are omitted in FIG. 17 although they do exist and are shown in FIG. 14 that is a block diagram of the computer system of the second embodiment. Furthermore, for convenience of illustration, the second external storage subsystem 6000 is similar in configuration with the first external storage subsystem 6000 and thus omitted in FIG. 17.

### (2) Operation of Third Embodiment

The third embodiment is similar in operation with the second embodiment described above except for the points described below. The subroutine performed by the event-sending program 1211 of the third embodiment is described next by referring to FIG. 8.

The event-sending program 1211 detects a fault (S1000) In the present specification, for convenience of illustration, the detected event is a fault. The detected event can be other events such as an instruction from other user or performance deterioration due to high load on the storage subsystem.

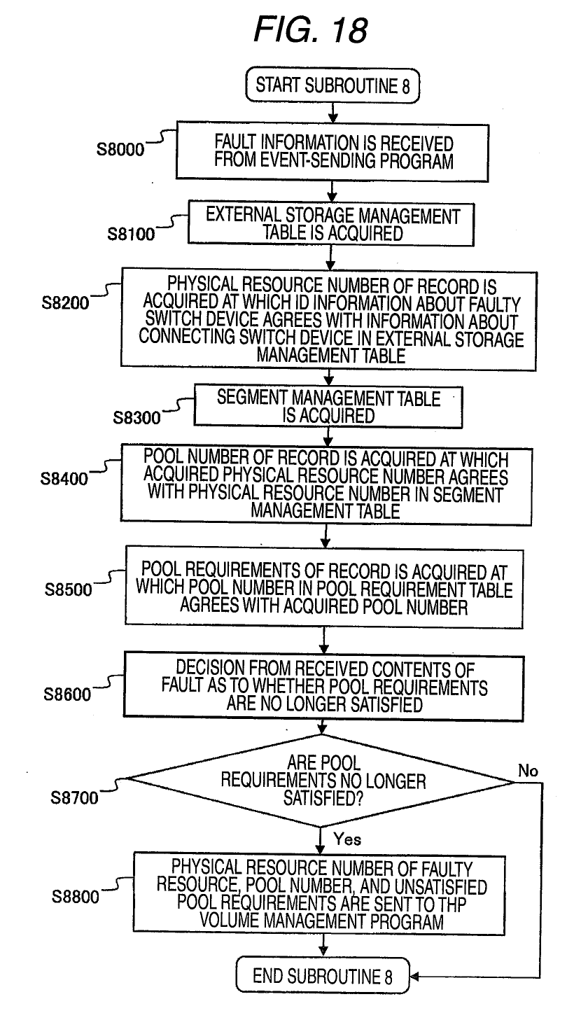

Then, the event-sending program 1211 sends information about the fault to the event reception program 4120. The information about the fault includes information for identification of a location where the fault has occurred, the contents of the fault, the importance, and the time at which the fault occurred. In the present specification, for convenience of illustration, it is assumed that a fault has occurred with the first switch device 7000 interconnecting the storage subsystem 1000 and first external storage subsystem 6000 and that the sent information for identifying a location where the fault has occurred is identification information about the first switch device 7000. The routine performed by the event reception program 4120 is described by referring to FIG. 18.

The event reception program 4120 receives fault information including identification information about the faulty first switch device 7000 from the event-sending program 6211 of the external storage subsystem 6000 (S8000).

Then, the event reception program 4120 acquires the external storage management table 1217 from the storage subsystem 1000 (S8100). Then, the event reception program 4120 acquires the physical source number T600 of a record where the identification information about the faulty first switch device 7000 is coincident with the connecting switch device T620 in the external storage management table 1217 (S8200).

The event reception program 4120 then acquires the segment management table 1215 from the storage subsystem 1000 (S8300). Subsequently, the event reception program 4120 acquires the pool number T300 of a record where the identification number of the physical resource obtained in the step S7200 is coincident with the physical resource number T310 in the segment management table 1215 (S8400).

The event reception program 4120 then acquires the pool requirement T510 of a record where the pool number obtained at the step S7400 is coincident with the pool number T500 in the pool requirement table 4150 (S8500).

Subsequently, the event reception program 4120 makes a decision from the received contents of fault as to whether the pool requirement T510 is no longer satisfied (S8600). If the decision is that the pool requirement is satisfied, the event reception program 4120 terminates the subroutine (S8700).

On the other hand, if the decision is that the pool requirement is no longer satisfied, the event reception program 4120 sends the physical resource number and pool number of the faulty physical resource to the thin provisioned volume management program 4110 as well as the pool requirement no longer satisfied (S8800).

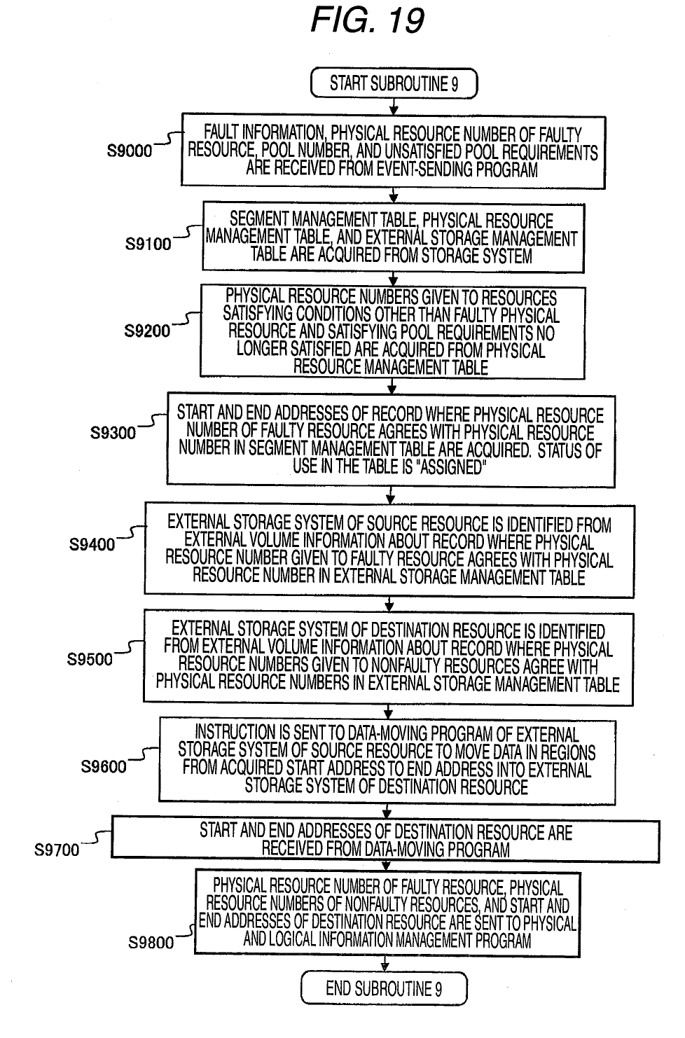

The routine performed by the segment-moving instruction program 4130 is described by referring to FIG. 19. The instruction program 4130 receives fault information, the physical resource number, and pool number of the faulty physical resource from the event reception program 4120 as well as the pool requirement no longer satisfied (S9000).

The segment-moving instruction program 4130 then acquires the segment management table 1215, physical resource management table 1216, and external storage management table 1217 from the storage subsystem 1000 (S9100).

The segment-moving instruction program 4130 then acquires the physical resource numbers given to physical resources, which satisfy the unsatisfied pool requirements and satisfy the conditions except for the faulty physical resource, from the physical resource management table (S9200).

The segment-moving instruction program 4130 then acquires the start address T230 and end address T240 of a record in which the physical resource number given to the faulty physical resource is coincident with the physical resource number T210 in the segment management table 1215 and in which the status of use T250 in the segment management table 1215 is “assigned” (S9300).

The segment-moving instruction program 4130 then identifies the external storage subsystem of the source resource from the external volume information T610 of a record where the physical resource number of the faulty physical resource is coincident with the physical resource number T600 in the external storage management table 1217 (S9400).

The segment-moving instruction program 4130 then identifies the external storage subsystem of the destination resource from the external volume information T610 of a record where the physical resource number of the physical resource satisfying the condition is coincident with the physical resource number T600 in the external storage management table 1217 (S9500).

The segment-moving instruction program 4130 sends an instruction to the data-moving program 6212 of the external storage subsystem of the source resource to move the data held in the region from the start address to the end address obtained at the step S9300 to the external storage subsystem of the destination resource (S9600). Then, the segment-moving instruction program 4130 receives the start and end addresses of the destination resource from the data-moving program (S9700).

Finally, the segment-moving instruction program 4130 determines the physical resource number of the faulty resource as the physical resource number of the source resource. The instruction program 4130 determines the physical resource number of the resource satisfying the condition as the physical resource number of the destination resource. The instruction program 4130 sends the start and end addresses of the destination resource to the segment-moving instruction program 1212 (S9800).

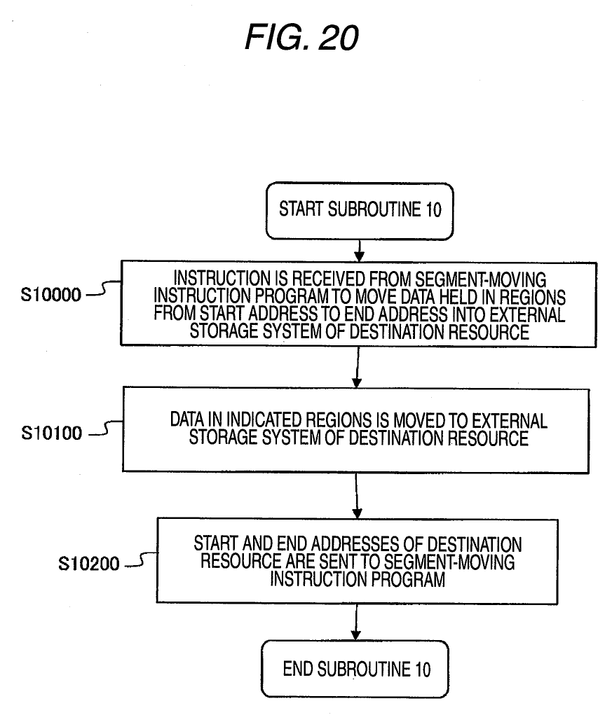

The subroutine executed by the data-moving program 6212 is described by referring to FIG. 20. The data-moving program 6212 receives an instruction for moving data held in the region from the start address to the end address given by the segment-moving instruction program to the external storage subsystem of the destination resource (S10000).

The data-moving program 6212 then moves the data held in the indicated region to the external storage subsystem of the destination resource (S10100). Then, the data-moving program 6212 sends start and end addresses of the destination resource to the segment-moving instruction program 4130 (S10200).

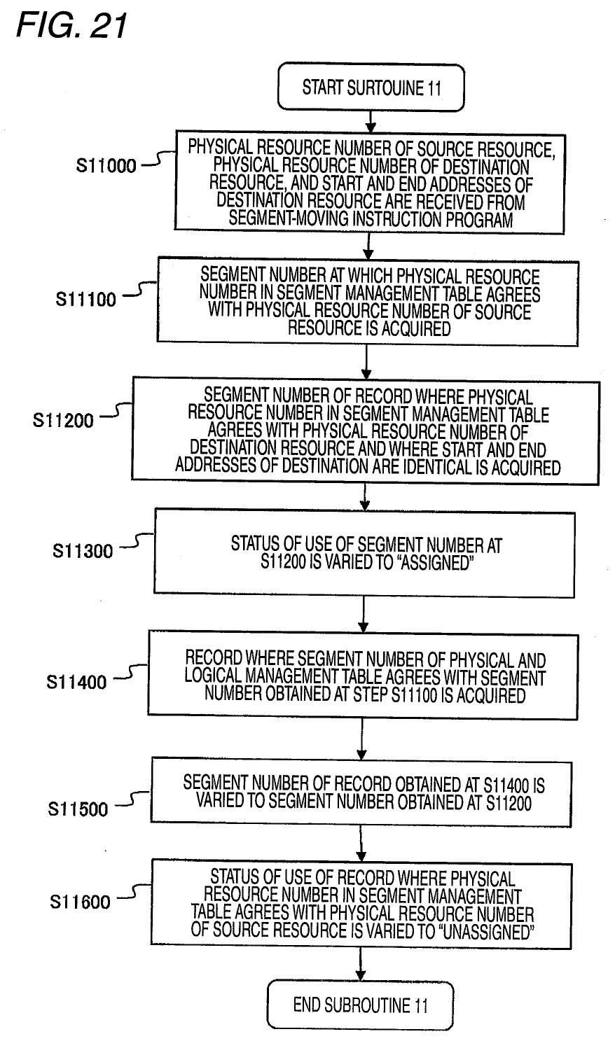

The routine executed by the physical and logical information management program 1213 is described by referring to FIG. 21. The management program 1213 receives the physical resource number of the source resource, the physical resource number of the destination resource, and start and end addresses of the destination resource from the segment-moving instruction program (S11000).

Then, the physical and logical information management program 1213 acquires a segment number at which the physical resource number T210 in the segment management table 1215 is coincident with the physical resource number of the destination resource (S11100).

The physical and logical information management program 1213 then acquires the segment number of a record at which the physical resource number T210 in the segment management table 1215 is coincident with the resource number of the destination resource, and at which the start and end addresses of the destination resource are coincident (S11200). Then, the physical and logical information management program 1213 modifies the status of use T250 of the segment number at the step S11200 to “assigned” (S11300).

Then, the physical and logical information management program 1213 acquires a record where the segment number T110 of the physical and logical management table 1214 is coincident with the segment number obtained at the step S111000 (S11400).

Then, the physical and logical information management program 1213 modifies the segment number of the record acquired at the step S11400 to the segment number acquired at the step S11200 (S11500).

Finally, the physical and logical information management program 1213 modifies the status of use T250 of a record where the physical resource number T210 in the segment management table 1215 is coincident with the physical resource number of the source resource to “unassigned” (S11600). The third embodiment is similar in operation with the second embodiment in other respects.

As described so far, the third embodiment yields the same advantages as the second embodiment under the system configuration where the entities of some physical resources of the storage subsystem 1000 are contained in the first external storage subsystem 6000 and second external storage subsystem 6000.

What is claimed is:

1. A method of moving data held in a logical volume, comprising the steps of:
preparing a storage subsystem for exchanging information with a host computer via a communication network and offering a storage region in a storage device to the host computer in response to an access from the host computer;
preparing an administrative computer for managing the storage region of the storage device as a thin provisioned volume;
causing the administrative computer to select a logical volume satisfying storage pool requirements of the thin provisioned volume when any region in the thin provisioned volume produces an event in which the storage pool requirements are not satisfied; and
causing the storage subsystem to rearrange some regions of the thin provisioned volume into the selected logical volume in response to an instruction from the administrative computer.

2. A method of moving data held in a logical volume as set forth in claim 1,
wherein said administrative computer makes a decision based on event information sent from the storage subsystem and on information about configuration of the logical volume as to whether the storage pool requirements of said thin provisioned volume are satisfied if and only if said event information is received, selects a data region satisfying the pool requirements if the decision is negative, and instructs the storage subsystem to move data from the data region no longer satisfying the pool requirements to the data region satisfying the pool requirements, and
wherein said storage subsystem sends event information to said administrative computer when an event has been detected, moves data from the data region no longer satisfying the pool requirements to the data region satisfying the pool requirements when an instruction regarding movement of the data is received from the administrative computer, and modifies the information about the configuration of the logical volume from the data region no longer satisfying the pool requirements to the data region satisfying the pool requirements.

3. A method of moving data held in a logical volume as set forth in claim 1,
wherein said administrative computer identifies those of physical resources to be accessed by the host computer which are affected by event information sent from the storage subsystem if and only if said event information is received, makes a decision as to whether the identified physical resources satisfy the storage pool requirements of the thin provisioned volume, selects physical resources capable of satisfying the pool requirements from the physical resources to be accessed if the decision at the previous step is negative, and instructs the storage subsystem to move data stored in the physical resources affected by the event information to the physical resources satisfying the pool requirements, and
wherein said storage subsystem sends event information to the administrative computer when an event has been detected, moves data stored in the physical resources affected by the event information to the physical resources satisfying the pool requirements when an instruction regarding movement of the data is received from the administrative computer, and modifies the physical resource numbers given to the physical resources affected by the event information to the physical resource numbers given to the physical resources satisfying the pool requirements.

4. A method of moving data held in a logical volume, comprising the steps of:
preparing plural storage subsystems for exchanging information with a host computer via a communication network and offering a storage region in a storage device to the host computer in response to an access from the host computer;
preparing an administrative computer for managing the storage region of the storage device as a thin provisioned volume;
causing the administrative computer to select a logical volume satisfying storage pool requirements of the thin provisioned volume when an event has occurred in which any regions of the thin provisioned volume fail to satisfy the pool requirements; and
causing one of the storage subsystems to rearrange some regions of the thin provisioned volume into the selected logical volume in response to an instruction from the administrative computer.

5. A method of moving data held in a logical volume as set forth in claim 4,
wherein said administrative computer makes a decision based on interrelationships among said event information, information about configuration of said logical volume, and said external storage subsystem as to whether storage pool requirements of the thin provisioned volume are satisfied if and only if the event information sent from the external storage subsystem out of said storage subsystems is received, selects data regions satisfying the pool requirements if the previous decision is negative, and instructs an indicated one of the storage subsystems to move data from data regions no longer satisfying the pool requirements to data regions satisfying the pool requirements,
wherein said external storage subsystem sends event information to the administrative computer when an event is detected, and
wherein the specified storage subsystem moves data from the data regions no longer satisfying the pool requirements to data regions satisfying the pool requirements when an instruction regarding movement of the data is received from the administrative computer and modifies information about configuration of the logical volume from the data regions no longer satisfying the pool requirements to the data regions satisfying the pool requirements.

6. A method of moving data held in a logical volume as set forth in claim 4,
wherein said administrative computer identifies those of physical resources to be accessed by the host computer which are affected by event information sent from the external storage subsystem out of said storage subsystems if and only if said event information is received, makes a decision as to whether the identified physical resources satisfy the storage pool requirements of the thin provisioned volume, selects physical resources capable of satisfying the pool requirements from the accessed physical resources if the decision at the previous step is negative, and instructs the specified one of the storage subsystems to move data stored in the physical resources affected by the event information to the physical resources satisfying the pool requirements,
wherein said external storage subsystem sends event information to the administrative computer when an event is detected, and
wherein the specified storage subsystem moves data stored in the physical resources affected by the event information to physical resources satisfying the pool requirements when an instruction regarding movement of the data is received from the administrative computer and modifies physical resource numbers assigned to the physical resources affected by the event information to physical resource numbers given to the physical resources satisfying the pool requirements.

7. A storage system comprising:
a storage subsystem for exchanging information with a host computer via a communication network and offering a storage region in a storage device to the host computer in response to an access from the host computer; and
an administrative computer for managing the storage region of the storage device as a thin provisioned volume;
wherein the administrative computer selects a logical volume satisfying storage pool requirements of the thin provisioned volume when an event occurs in which any region in the thin provisioned volume fails to satisfy the pool requirements; and
wherein the storage subsystem rearranges some regions of the thin provisioned volume into the selected logical volume in response to an instruction from the administrative computer.

8. A storage system as set forth in claim 7,
wherein said administrative computer makes a decision based on event information sent from the storage subsystem and on information about configuration of the logical volume as to whether the storage pool requirements of said thin provisioned volume are satisfied if and only if said event information is received, selects a data region satisfying the pool requirements if the decision is negative, and instructs the storage subsystem to move data from the data region no longer satisfying the pool requirement to the data region satisfying the pool requirements, and
wherein said storage subsystem sends event information to said administrative computer when an event has been detected, moves data from the data region no longer satisfying the pool requirements to the data region satisfying the pool requirements when an instruction regarding movement of the data is received from the administrative computer, and modifies the information about the configuration of the logical volume from the data region no longer satisfying the pool requirements to the data region satisfying the pool requirements.

9. A storage system as set forth in claim 7,
wherein said administrative computer identifies those of physical resources to be accessed by the host computer which are affected by event information sent from the storage subsystem if and only if said event information is received, makes a decision as to whether the identified physical resources satisfy the storage pool requirements of said thin provisioned volume, selects physical resources capable of satisfying the pool requirements from the accessed physical resources if the decision is negative, and instructs the storage subsystem to move data stored in the physical resources affected by the event information to the data resources satisfying the pool requirements, and
wherein said storage subsystem sends event information to said administrative computer when an event has been detected, moves data stored in the physical resources affected by the event information to the physical resources satisfying the pool requirements when an instruction regarding movement of the data is received from the administrative computer, and modifies physical resource numbers given to the physical resources affected by the event information to the physical resource numbers given to the physical resources satisfying the pool requirements.

10. A storage system comprising:
plural storage subsystems for exchanging information with a host computer via a communication network and offering a storage region in a storage device to the host computer in response to an access from the host computer; and
an administrative computer for managing the storage region of the storage device as a thin provisioned volume;
wherein the administrative computer selects a logical volume satisfying storage pool requirements of the thin provisioned volume when any region in the thin provisioned volume produces an event in which the pool requirements are no longer satisfied; and
wherein one of the storage subsystems rearranges some regions of the thin provisioned volume into the selected logical volume in response to an instruction from the administrative computer.

11. A storage system as set forth in claim 10,
wherein said administrative computer makes a decision based on event information sent from external storage subsystems of said plural storage subsystems, on information about configuration of the logical volume, and on interrelationships among the external storage subsystems as to whether storage pool requirements of said thin provisioned volume are satisfied if and only if said event information is received, selects data regions satisfying the pool requirements if the decision is negative, and instructs a specified one of the storage subsystems to move data from the data regions no longer satisfying the pool requirements to the data regions satisfying the pool requirements,
wherein said external storage subsystems send event information to said administrative computer when an event has been detected, and
wherein the specified storage subsystem moves data from the data regions no longer satisfying the pool requirements to the data regions satisfying the pool requirements when an instruction regarding movement of the data is received from the administrative computer, and modifies the information about the configuration of the logical volume from the data regions no longer satisfying the pool requirements to the data regions satisfying the pool requirements.

12. A storage system as set forth in claim 10,
wherein said administrative computer identifies those of physical resources to be accessed by the host computer which are affected by event information sent from the external storage subsystems of said storage subsystems if and only if said event information is received, makes a decision as to whether the identified physical resources satisfy the storage pool requirements of said thin provisioned volume, selects physical resources capable of satisfying the pool requirements from the accessed physical resources if the decision is negative, and instructs a specified one of the storage subsystems to move data stored in the physical resources affected by the event information to the physical resources satisfying the pool requirements,
wherein said external storage subsystems send event information to said administrative computer when an event has been detected, and
wherein the specified storage subsystem moves data stored in the physical resources affected by the event information to the physical resources satisfying the pool requirements when an instruction regarding movement of the data is received from the administrative computer, and modifies physical resource numbers given to the physical resources affected by the event information to the physical resource numbers given to the physical resources satisfying the pool requirements.

13. An administrative computer having an administrative portion for exchanging information with a storage subsystem that offers a storage region in a storage device to a host computer and for managing the storage region of the storage device as a thin provisioned volume,
wherein said administrative portion selects a logical volume satisfying storage pool requirements of the thin provisioned volume when an event has occurred in which any regions of the thin provisioned volume do not satisfy the pool requirements and sends an instruction to the storage subsystem to rearrange some regions of the thin provisioned volume into the selected logical volume.

14. An administrative computer as set forth in claim 13, wherein said administrative portion makes a decision based on event information sent from the storage subsystem and on information about configuration of the logical volume if and only if said event information has been received, selects data regions satisfying the pool requirements if the decision is negative, and instructs the storage subsystem to move data from the data regions no longer satisfying the pool requirements to data regions satisfying the pool requirements.

15. An administrative computer as set forth in claim 13, wherein said administrative portion identifies physical resources affected by said event information from physical resources to be accessed by the host computer if and only if event information sent from the storage subsystem has been received, makes a decision as to whether the identified physical resources satisfy the pool requirements of the thin provisioned volume, selects physical resources capable of satisfying the pool requirement from the accessed physical resources if the decision is negative, and instructs the storage subsystem to move data stored in the physical resources affected by the event information to the physical resources satisfying the pool requirements.
